(19) United States
(12) Patent Application Publication
(10) Pub. No.: US 2016/0041919 A1
(43) Pub. Date: Feb. 11, 2016

(54) SYSTEM AND METHOD FOR SELECTIVE SUB-PAGE DECOMPRESSION

(71) Applicant: QUALCOMM INCORPORATED, SAN DIEGO, CA (US)

(72) Inventors: PHILIP MICHAEL HAWKES, WARRIMOO (AU); ANAND PALANIGOUNDER, SAN DIEGO, CA (US)

(21) Appl. No.: 14/455,663

(22) Filed: Aug. 8, 2014

(51) Int. Cl. G06F 12/10; G06F 12/08

(52) U.S. Cl. CPC G06F 12/1009; G06F 12/0802; G06F 2212/502

(57) ABSTRACT

Various embodiments of methods and systems for Selective Sub-Page Decompression (“SSPD”) seek to reduce unwanted latency in making requested data available to a processing component. To do so, SSPD embodiments may decompress a memory page in sub-page segments. Certain SSPD embodiments may decompress the sub-pages in parallel, using a plurality of available decompression engines. Certain other SSPD embodiments may decompress the sub-pages in a serial manner, using one or more available decompression engines and starting with a target sub-page that contains a requested chunk of data. In these ways, SSPD embodiments may make a requested chunk of data available to a processing component more quickly than other systems and methods known in the art.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices. PCDs commonly contain integrated circuits, or systems on a chip (“SoC”), that include numerous components designed to work together to deliver functionality to a user. Generally speaking, the more functionality that a PCD is required to provide to a user, the more processing components and memory components a designer must find space for on the SoC.

With the limited space of today's PCD form factors being in conflict with the demand for more functionality, designers look for processing and memory components that maximize processing and storage capacity per amount of space taken up on the SoC. Additionally, PCD designers look for ways to better utilize the processing and memory capacity available in the PCD, thereby possibly mitigating the need to squeeze in additional or physically larger components.

Memory capacity, in particular, requires an inordinate amount of space on a typical SoC. Consequently, designers are always interested in ways to minimize the amount of storage capacity that is needed to deliver target levels of functionality. One way that memory capacity is kept at a minimum is by using compression techniques to store data streams in a compact manner. Compression of data reduces the amount of memory needed (thus saving space) and the amount of bandwidth required to transmit data to processing components (thus conserving bus bandwidth for other functionality) as well as minimizes the amount of energy consumed for data storage.

Data such as executable code is commonly compressed in a sequence of pages. As such, when a processing component requests a certain piece of executable code located within a certain page, systems and methods known in the art fetch and decompress the entire page, from beginning to end, before ultimately making the decompressed page of code available to the processing component. A downside of such systems and methods is that latency in providing the requested executable code to the processing component may be detrimentally high when the requested executable code is located in a latter portion of the certain page. Therefore, there is a need in the art for a system and method that recognizes sub-page groupings of compressed data within a memory page and prioritizes decompression of the sub-pages based on the location of the requested executable code and available decompression engines.

### SUMMARY OF THE DISCLOSURE

Various embodiments of methods and systems for selective sub-page decompression (“SSPD”) of a memory page in a system on a chip (“SoC”) in a portable computing device (“PCD”) are disclosed. An exemplary SSPD embodiment is triggered by receipt of a request from a processing engine for certain executable code that is stored in a compressed form in a memory device and is associated with a memory page. The method then retrieves the memory page and subdivides it into a plurality of sub-pages ordered from a first sub-page to a last sub-page such that a certain sub-page of the plurality of sub-pages comprises the certain executable code. Notably, the certain sub-page that includes the certain executable code may not be the first sub-page. The method then decompresses the sub-pages, beginning with the certain sub-page so that the certain executable code is decompressed as early as possible in the decompression step of the method. The certain sub-page containing the certain executable code, having been decompressed, is provided to the processing engine. Advantageously, SSPD embodiments may optimize the latency for providing decompressed code to a requesting processing engine when the requested code is stored at a location in a memory page that is not near the beginning of the memory page.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram illustrating an embodiment of an on-chip system for decompressing a data stream according to selective sub-page decompression (“SSPD”) techniques;

FIG. 2A is a functional block diagram illustrating an exemplary full parallel selective sub-page decompression (“FP-SSPD”) technique;

FIG. 2B is a logical flowchart illustrating a method for selective sub-page decompression (“SSPD”) according to a full parallel selective sub-page decompression (“FP-SSPD”) embodiment;

FIG. 3A is a functional block diagram illustrating an exemplary partially parallel selective sub-page decompression (“PP-SSPD”) technique;

FIG. 3B is a logical flowchart illustrating a method for selective sub-page decompression (“SSPD”) according to a partially parallel selective sub-page decompression (“PP-SSPD”) embodiment;

FIG. 4A is a functional block diagram illustrating an exemplary full ordered serial selective sub-page decompression (“FS-SSPD”) technique;

FIG. 4B is a logical flowchart illustrating a method for selective sub-page decompression (“SSPD”) according to a full ordered serial selective sub-page decompression (“FS-SSPD”) embodiment;

FIG. 5 is a functional block diagram illustrating an exemplary, non-limiting aspect of a portable computing device (“PCD”) in the form of a wireless telephone for implementing selective sub-page decompression (“SSPD”) techniques; and

FIG. 6 is a schematic diagram illustrating an exemplary software architecture of the PCD of FIG. 5 for implementing selective sub-page decompression (“SSPD”) solutions.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, reference to a “cache” or a “tightly coupled memory” are used interchangeably and will be understood to envision any memory device in which may be stored decompressed data (e.g., decompressed executable code) for the benefit of a requesting processing component.

In this description the terms “code,” “data stream,” “image,” “data,” “executable code” and the like are used interchangeably. Depending on the context of their use, it will be understood that a “code,” “data stream,” “image,” “data,” “executable code” may be uncompressed, compressed or decompressed. Moreover, reference to a particular executable code or particular portion of executable code will be understood to mean a portion of executable code comprised within a sub-page of a memory page.

In this description, the terms “memory page” and “page” are used interchangeably to refer to a standard unit of data that may be fetched from a memory component, such as a double data rate memory, FLASH memory, or other non-volatile storage device. Although exemplary embodiments of the solutions are described herein within the context of a system that requests compressed data from storage in 4 KB memory page chunks, it will be understood that embodiments of the solutions are not limited in applicability to memory pages that are 4 KB in size. That is, reference to 4 KB pages is for illustrative purposes only and will not suggest that other page sizes are not envisioned. Moreover, although certain exemplary embodiments of the solution are described within the context of 4 KB memory pages processed as a group of 1 KB sub-pages, it will be understood that other sub-page sizes, or ratios of sub-page size to memory page size, are envisioned and within the scope of the proposed solutions.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or chip may be comprised of one or more distinct processing components generally referred to herein as “core(s).”

In this description, the terms “engine,” “processing engine,” “processor,” “processing component” and the like are used to refer to any component within a system on a chip (“SoC”) that may request decompressed data and/or executable code that is stored in a memory component in a compressed format. As such, a processing engine may refer to, but is not limited to refer to, a CPU, DSP, GPU, modem, controller, etc.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3 G”) and fourth generation (“4 G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

As discussed above, on-chip memory is a large consumer of space on a SoC. The ever increasing demand for functionality has led designers to add more memory and different cache hierarchies in an effort to accommodate all the data needed in order to deliver the functionality. Tightly coupled memory, i.e. lean, low-latency memory dedicated to a given processing component, has become more and more common in SoCs to ensure that processing components have efficient and quick access to the data they need.

Many prior art codec algorithms rely on a look-back period in order to recognize patterns during compression. Such codecs take a frequent pattern compression (“FPC”) approach which compresses memory pages in a data stream based on a “look back” that identifies a previous instance of code having the same word pattern. If a data pattern is repeated in the stream, it may be plugged into a dictionary so that the stream may be compressed by replacing all instances of the word pattern with an index pointing to the dictionary. For example, if an FPC compression methodology recognizes an A, B, C, D, E word pattern in a data stream it is compressing, and looking back 5 MB in the stream it recognizes the same pattern, then a pointer indicating that the pattern has been seen in the data before is inserted such that when decompressing the stream the words may simply be copied from the location of its first instance.

Once an image is compressed, such as by using an FPC approach, it may be stored in a non-volatile memory device such as a double data rate (“DDR”) memory. The compressed image is stored in memory page sized chunks, such as 4 KB pages. A processing component in need of a certain piece of data within the compressed image may issue a request for the certain piece of data, as is understood by one of ordinary skill in the art. Notably, because the requested data is inevitably contained within a memory page, the entire memory page may have to be retrieved and decompressed before the requested piece of data can be provided to the processing component. This reality may introduce unwanted latency into the process, as the “unrequested” data included in the memory page is decompressed along with the requested data—i.e., the processing component may have to wait on the entire memory page to be decompressed before it can have access to the portion of the memory page it requested.

Advantageously, Selective Sub-Page Decompression (“SSPD”) techniques seek to reduce unwanted latency in making requested data available to a processing component. To do so, SSPD embodiments may decompress a memory page in sub-page segments. Certain SSPD embodiments may decompress the sub-pages in parallel, using a plurality of available decompression engines. Certain other SSPD embodiments may decompress the sub-pages in a serial manner, using one or more available decompression engines and starting with a sub-page that contains a requested chunk of data. In these ways, SSPD embodiments may make a requested chunk of data available to a processing component more quickly than other systems and methods known in the art.

For example, an SSPD embodiment employing a Full Parallel Selective Sub-Page Decompression (“FP-SSPD”) technique may divide a memory page into a number of sub-pages that is equivalent to the number of available decompression engines. Each decompression engine then may work in parallel with the others to decompress one of the sub-pages. In this way, the entire memory page may be decompressed in the amount of time it takes to decompress one of the sub-pages. The entire memory page worth of decompressed data may then be made available to a processing component.

As another example, an SSPD embodiment employing a Partially Parallel Selective Sub-Page Decompression (“PP-SSPD”) technique may divide a memory page into a number of sub-pages that is divisible by the number of available decompression engines. Each decompression engine then may work in parallel with the others to decompress a set of multiple sub-pages each. In this way, the entire memory page may be decompressed in the amount of time it takes to decompress one of the sets of sub-pages. It is envisioned that PP-SSPD embodiments may divide a memory page into sets of sub-pages such that a requested chunk of data resides in a first sub-page of a given set. In doing so, PP-SSPD embodiments may be able to make a requested chunk of data available to a processing engine before the entire memory page is decompressed.

As another example, an SSPD embodiment employing a Full Ordered Serial Selective Sub-Page Decompression (“FS-SSPD”) technique may divide a memory page into a number of sub-pages for decompression by a single decompression engine. Although the amount of time required to decompress the entire memory page may not be significantly better than other decompression methodologies, FS-SSPD solutions may selectively determine a starting point within the memory page to begin decompression. In doing so, FS-SSPD embodiments may start decompression at a certain sub-page that includes a requested chunk of data so that the decompressed requested chunk of data may be made available to a processing engine before the entire memory page is decompressed.

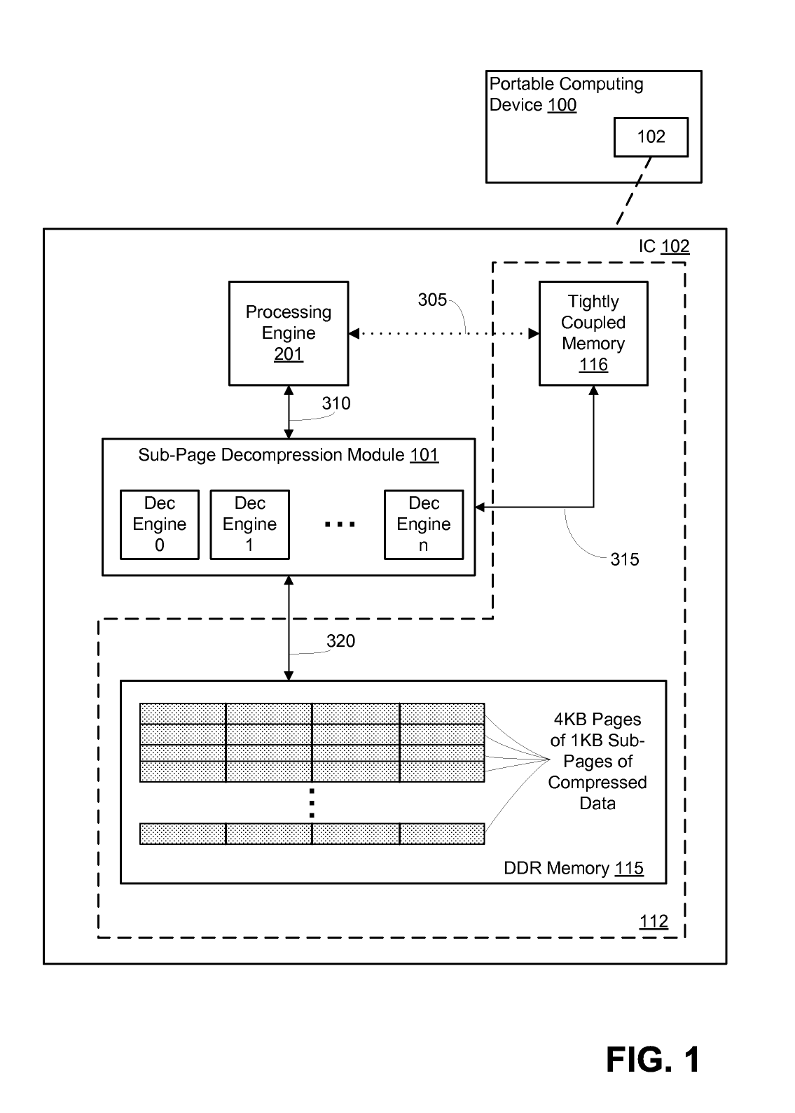

Turning now to the figures, FIG. 1 is a functional block diagram illustrating an embodiment of an on-chip system 102 for decompressing a data stream according to selective sub-page decompression (“SSPD”) techniques. As can be seen in the FIG. 1 illustration, a processing engine 201 is associated with a tightly coupled memory device 116, such as a cache memory device. As would be understood by one of ordinary skill in the art, the processing engine 201 may query the cache 116 (communication 305) for decompressed executable code before requesting that the code be provided from a slower memory, such as double data rate (“DDR”) memory 115.

As illustrated in FIG. 1, the DDR memory 115 stores compressed data that may include data points, executable code, and the like as would be understood by one of ordinary skill in the art. The data stored in DDR 115 may have been compressed according to any number of data compression techniques. For exemplary purposes, the compressed data depicted in DDR 115 is shown organized in 4 KB memory pages which is further shown subdived into four 1 KB sub-pages according to an SSPD embodiment, for example. Notably, although the memory pages and sub-pages are illustrated as being 4 KB and 1 KB in size, respectively, it will be understood that SSPD embodiments are not limited in applicability to 4 KB memory pages and 1 KB sub-pages. It is envisioned that SSPD embodiments may accommodate larger or smaller memory page sizes and may subdivide a given memory page into any number of sub-pages and/or groups of sub-pages as may be optimal.

A sub-page decompression (“SPD”) module 101 may intercept or receive a request 310 from the processing engine 201 for executable code that is stored in DDR 115 in a compressed format. The SPD module 101 may then send a request 320 to the DDR 115 for a memory page of compressed data that includes the executable code needed by the processing engine 201. Advantageously, using one or more SSPD techniques, the SPD module 101 may decompress the code and copy 315 it to the cache 116. Once in the cache 116, the executable code needed by the processing component 201 may be accessed 305 in the cache 116.

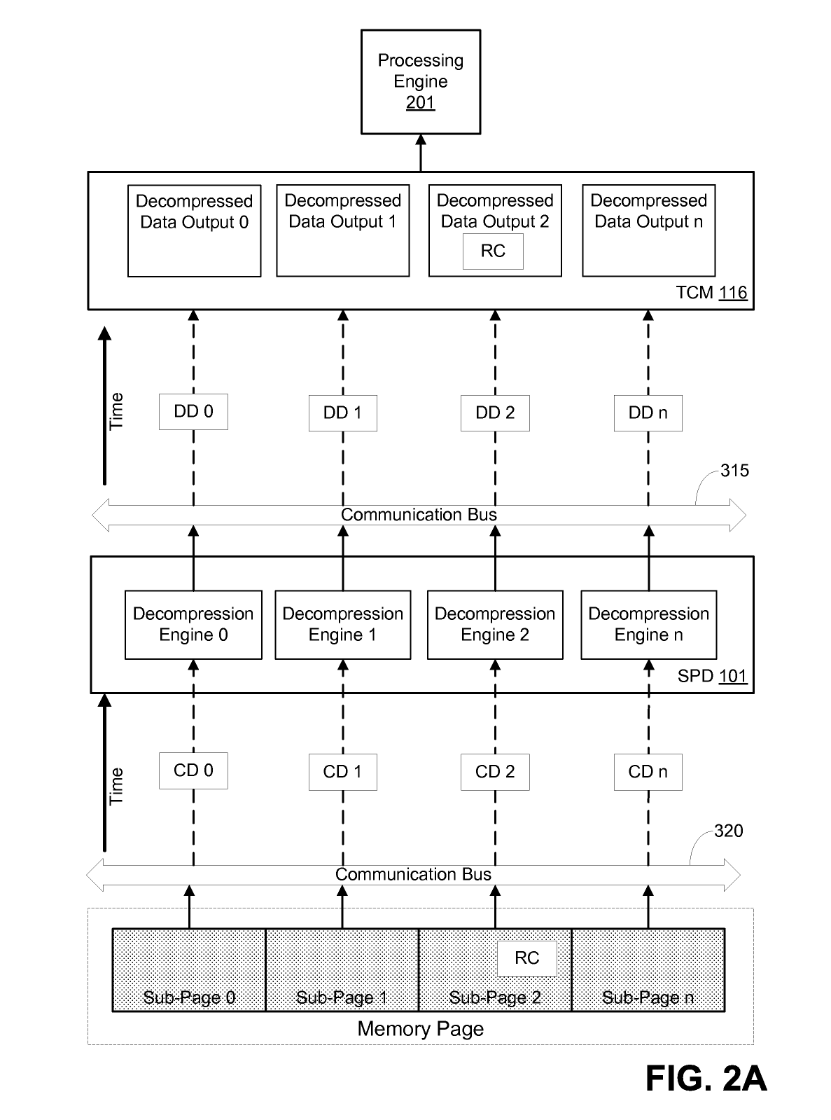

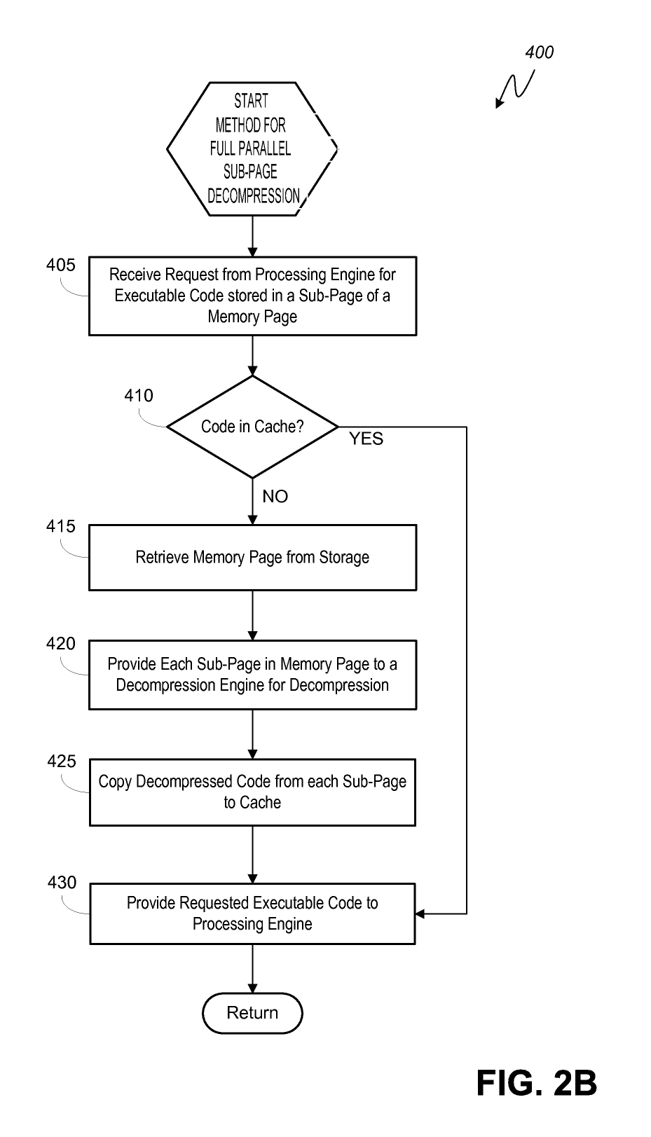

FIG. 2A is a functional block diagram illustrating an exemplary full parallel selective sub-page decompression (“FP-SSPD”) technique. At the base of the FIG. 2A illustration, an exemplary memory page of compressed data is depicted as being subdivided into “n” sub-pages—Sub-Page 0, Sub-Page 1, Sub-Page 2 and Sub-Page n. Notably, a specific piece of requested code RC resides in Sub-Page 2.

For the purpose of describing the FP-SSPD technique, suppose that processing engine 201 issues a request for the requested code RC. Using “n” decompression engines, the SPD module 101 may retrieve 320 the entire memory page and assign each of the “n” decompression engines with the task of decompressing the compressed data (CD 0, CD 1, CD 2, CD n) residing in the “n” sub-pages, respectively. In this way, each of the “n” sub-pages may be decompressed in parallel such that each sub-page worth of decompressed data (DD0, DD1, DD 2, DD n) is provided to the tightly coupled memory 116 substantially at the same time. Notably, in an FP-SSPD embodiment, the more decompression engines that are available to the SPD module 101 the faster the entire memory page may be decompressed due to the ability to subdivide the memory page into smaller sub-page sizes.

Moreover, as can be seen relative to the timelines included in the FIG. 2A illustration, the compressed sub-pages of data (CD 0, CD 1, CD 2, CD n) are provided to the respective decompression engines substantially in parallel. Consequently, the decompressed sub-pages of data (DD0, DD1, DD 2, DD n) are provided to the cache 116 substantially in parallel. In this way, the requested code RC may be made available to the processing engine 201 in the amount of time required to decompress a single sub-page, as opposed to the amount of time that would be required for a single decompression engine to either decompress the entire memory page or, alternatively, the first three sub-pages of the memory page.

FIG. 2B is a logical flowchart illustrating a method 400 for selective sub-page decompression (“SSPD”) according to a full parallel selective sub-page decompression (“FP-SSPD”) embodiment. Beginning at block 405, a request from a processing engine 201 for certain requested executable code (“RC”) stored in a sub-page of a memory page may be received by an SPD module 101. At decision block 410, the processing engine may have requested the RC from its associated cache, such as tightly coupled memory 116. If the RC has been previously decompressed and a copy of it remains in the cache 116, the method 400 follows the “yes” branch to block 430 and the requested executable code RC is provided to the processing engine 201. If the RC is not instantiated in the cache 116, then the “no” branch is followed to block 415 and the SPD module 101 proceeds to fulfill the request.

At block 415, the SPD module 101 may retrieve a memory page from a storage device, such as DDR 115. As described above, the memory page may be viewed by the SPD module 101 as being divided into a plurality of sub-pages, one of which contains the RC. Notably, it is envisioned that a memory page may be divided into a number of sub-pages based on the number of available decompression engines. For example, if four decompression engines are available and authorized for decompressing code, the memory page may be divided into four sub-pages so that each available decompression engine may decompress a sub-page substantially equal in size to the other sub-pages that make up the memory page.

Returning to the method 400 at block 420, the SPD module 101 may provide a sub-page to each of the available decompression engines for decompression of the code residing in the sub-pages. Advantageously, with each sub-page in the memory page being provided in parallel to a decompression engine, the entire memory page may be decompressed in the amount of time it takes to decompress one of the sub-pages (assuming all available decompression engines have similar processing capabilities).

At block 425, the decompressed code of each sub-page, including the requested code RC in a certain one of the sub-pages, may be copied to the cache 116 and made available to the processing component 201. At block 430, the requested code RC, having been decompressed by one of the decompression engines at block 420 and copied to the cache 116 at block 425, may be provided to the processing engine 201. The method 400 returns.

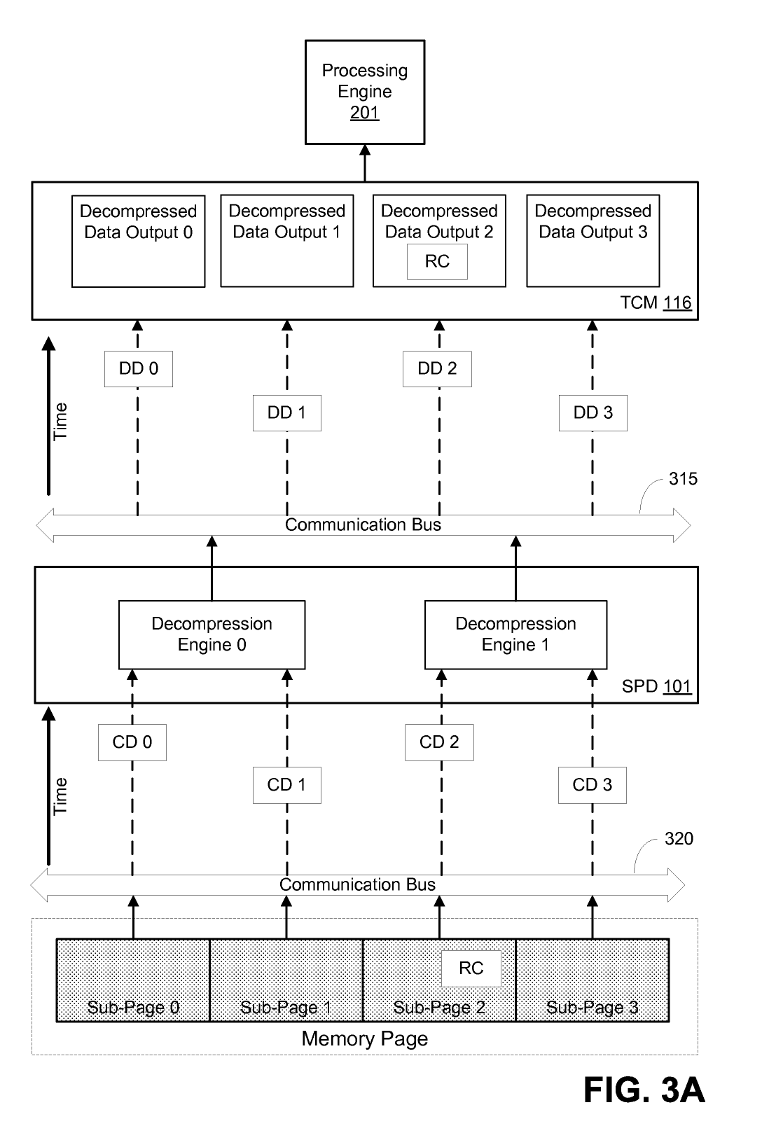

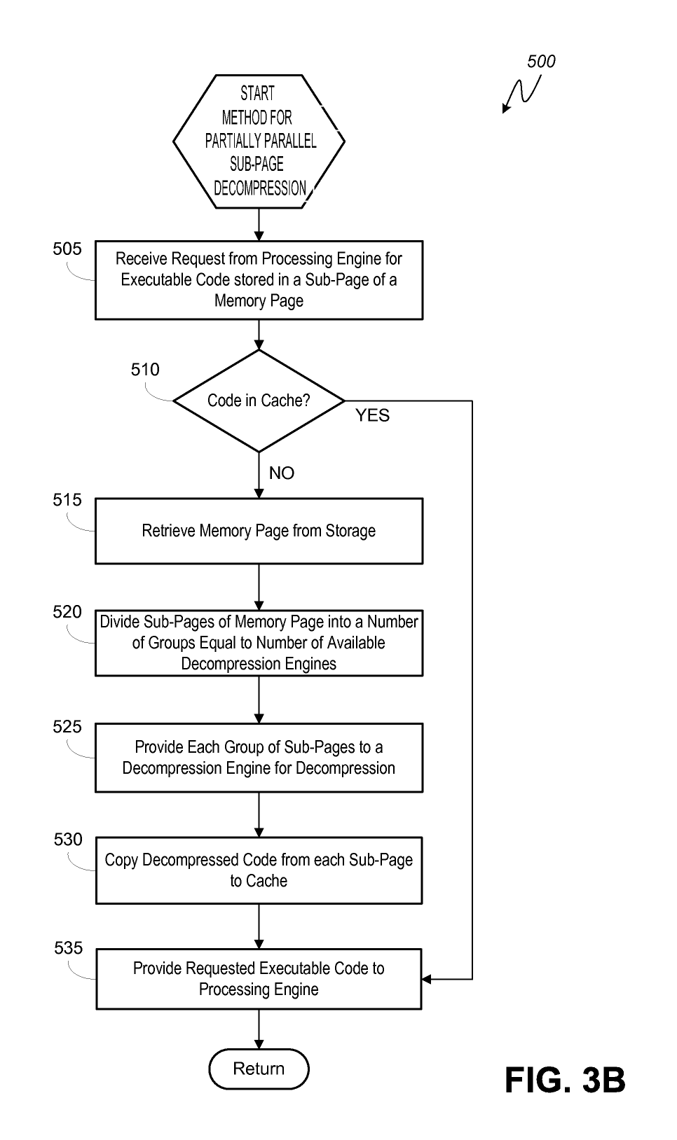

FIG. 3A is a functional block diagram illustrating an exemplary partially parallel selective sub-page decompression (“PP-SSPD”) technique. At the base of the FIG. 3A illustration, an exemplary memory page of compressed data is depicted as being subdivided into four sub-pages—Sub-Page 0, Sub-Page 1, Sub-Page 2 and Sub-Page 3, although it is envisioned that a sub-page may be divided into more or less than four sub-pages. Notably, a specific piece of requested code RC resides in Sub-Page 2.

For the purpose of describing the PP-SSPD technique, suppose that processing engine 201 issues a request for the requested code RC. Using a number of decompression engines that is divisible into the number of sub-pages (two decompression engines and four sub-pages, for example), the SPD module 101 may retrieve 320 the entire memory page and assign each of the available decompression engines with the task of decompressing the compressed data (CD 0, CD 1, CD 2, CD 3) residing in an equal number of sub-pages. For example, the SPD module 101 may assign Decompression Engine 0 with the task of decompressing Sub-Page 0 and Sub-Page 1 while assigning Decompression Engine 1 with the task of decompressing Sub-Page 2 and Sub-Page 3. In this way, each subset of the sub-pages may be decompressed in parallel such that each sub-page worth of decompressed data (DD0, DD1, DD 2, DD 3) is provided to the tightly coupled memory 116 as it is decompressed by its assigned decompression engine. Notably, in a PP-SSPD embodiment, the more decompression engines that are available to the SPD module 101 the faster the entire memory page may be decompressed due to the ability to subdivide the memory page into smaller subsets of sub-pages.

Moreover, as can be seen relative to the timelines included in the FIG. 3A illustration, the exemplary compressed sub-pages of data (CD 0 and CD 2) are provided to the respective decompression engines substantially in parallel with compressed sub-pages (CD 1 and CD 3) being provided in parallel thereafter. Consequently, the decompressed sub-pages of data (DD 0 and DD 2) are provided to the cache 116 substantially in parallel and at the same time with the decompressed sub-pages of data (DD 1 and DD 3) being provided thereafter. In this way, the requested code RC may be made available to the processing engine 201 in the amount of time required to decompress a single sub-page, as opposed to the amount of time that would be required for a single decompression engine to either decompress the entire memory page or, alternatively, the first three sub-pages of the memory page.

FIG. 3B is a logical flowchart illustrating a method 500 for selective sub-page decompression (“SSPD”) according to a partially parallel selective sub-page decompression (“PP-SSPD”) embodiment. Beginning at block 505, a request from a processing engine 201 for certain requested executable code (“RC”) stored in a sub-page of a memory page may be received by an SPD module 101. At decision block 510, the processing engine 201 may have requested the RC from its associated cache, such as tightly coupled memory 116. If the RC has been previously decompressed and a copy of it remains in the cache 116, the method 500 follows the “yes” branch to block 535 and the requested executable code RC is provided to the processing engine 201. If the RC is not instantiated in the cache 116, then the “no” branch is followed to block 515 and the SPD module 101 proceeds to fulfill the request.

At block 515, the SPD module 101 may retrieve a memory page from a storage device, such as DDR 115. As described above, the memory page may be viewed by the SPD module 101 as being divided into a plurality of sub-pages, one of which contains the RC. Notably, it is envisioned that a memory page may be divided into a number of sub-pages based on the number of available decompression engines, as indicated by block 520 of the method 500. For example, if two decompression engines are available and authorized for decompressing code, the memory page may be divided into four sub-pages so that each available decompression engine may decompress a set of sub-pages substantially equal in size to the other set of sub-pages that make up the memory page.

Returning to the method 500 at block 525, the SPD module 101 may provide a set of sub-pages to each of the available decompression engines for decompression of the code residing in the sub-pages. Advantageously, with each set of sub-pages in the memory page being provided in parallel to a decompression engine such that a first sub-page in one set includes the requested code RC, the requested code RC may be made available to the processing engine 201 in the amount of time required for one decompression engine to decompress a single sub-page chunk of code.

At block 530, the decompressed code of each sub-page, including the requested code RC in a certain one of the sub-pages, may be copied to the cache 116 and made available to the processing component 201. Advantageously, if a first sub-page in a given set of sub-pages includes the requested code RC, then the decompressed requested code RC may be made be copied to the cache 116 before other sub-pages are decompressed. At block 535, the requested code RC, having been decompressed by one of the decompression engines at block 525 and copied to the cache 116 at block 530, may be provided to the processing engine 201. The method 500 returns.

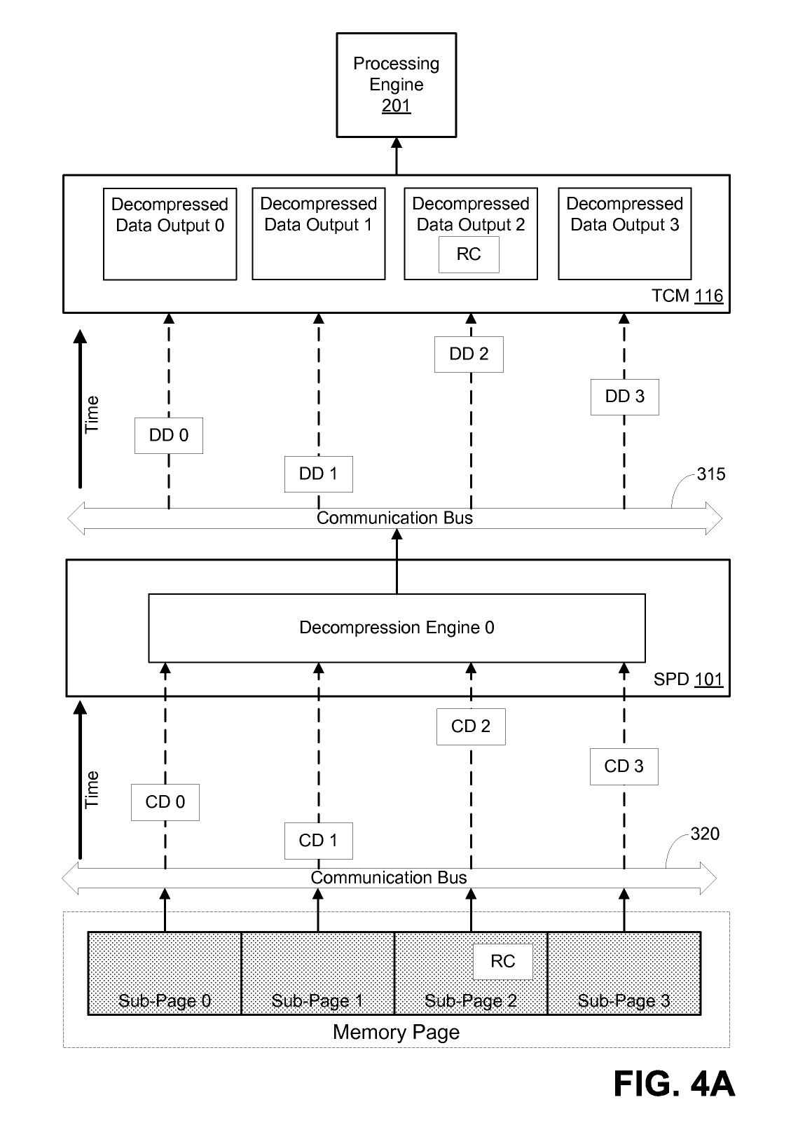

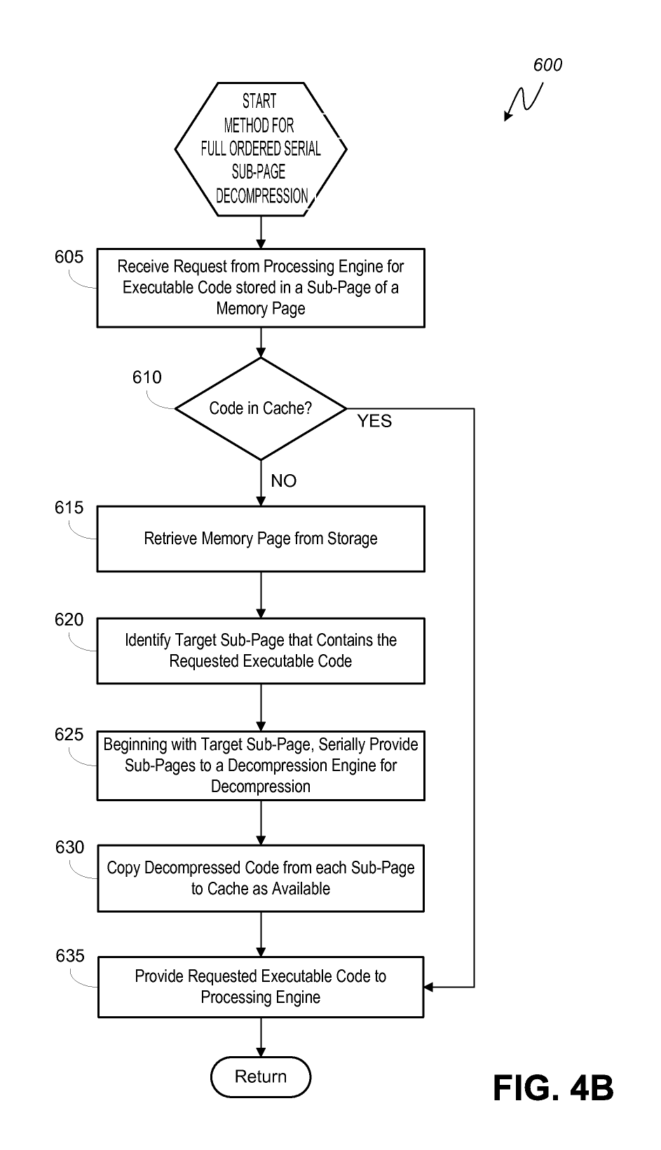

FIG. 4A is a functional block diagram illustrating an exemplary full ordered serial selective sub-page decompression (“FS-SSPD”) technique. At the base of the FIG. 4A illustration, an exemplary memory page of compressed data is depicted as being subdivided into four sub-pages—Sub-Page 0, Sub-Page 1, Sub-Page 2 and Sub-Page 3, although it is envisioned that a sub-page may be divided into more or less than four sub-pages. Notably, a specific piece of requested code RC resides in Sub-Page 2.

For the purpose of describing the FS-SSPD technique, suppose that processing engine 201 issues a request for the requested code RC. Using a single available decompression engine, Decompression Engine 0, the SPD module 101 may retrieve 320 the entire memory page and assign Decompression Engine 0 with the task of decompressing the compressed data (CD 0, CD 1, CD 2, CD 3) beginning with CD 2. In this way, each of the sub-pages may be decompressed in series, starting with Sub-Page 2, such that each sub-page worth of decompressed data (DD0, DD1, DD 2, DD 3) is provided to the tightly coupled memory 116 as it is decompressed by the decompression engine.

Advantageously, as can be seen relative to the timelines included in the FIG. 4A illustration, the exemplary compressed sub-pages of data (CD 2, CD 3, CD 0, CD 1) are provided in a serial order beginning with CD 2 which contains the requested code RC. Consequently, the decompressed sub-pages of data (DD 2, DD 3, DD 0, DD 1) are provided to the cache 116 substantially in the same order. In this way, the requested code RC may be made available to the processing engine 201 in the amount of time required to decompress a single sub-page, as opposed to the amount of time that would be required for a single decompression engine to either decompress the entire memory page or, alternatively, the first three sub-pages of the memory page.

FIG. 4B is a logical flowchart illustrating a method 600 for selective sub-page decompression (“SSPD”) according to a full ordered serial selective sub-page decompression (“FS-SSPD”) embodiment. Beginning at block 605, a request from a processing engine 201 for certain requested executable code (“RC”) stored in a sub-page of a memory page may be received by an SPD module 101. At decision block 610, the processing engine 201 may have requested the RC from its associated cache, such as tightly coupled memory 116. If the RC has been previously decompressed and a copy of it remains in the cache 116, the method 600 follows the “yes” branch to block 635 and the requested executable code RC is provided to the processing engine 201. If the RC is not instantiated in the cache 116, then the “no” branch is followed to block 615 and the SPD module 101 proceeds to fulfill the request.

At block 615, the SPD module 101 may retrieve a memory page from a storage device, such as DDR 115. As described above, the memory page may be viewed by the SPD module 101 as being divided into a plurality of sub-pages, one of which contains the RC. Notably, it is envisioned that a memory page may be divided into any number of sub-pages with one sub-page targeted to include the requested code RC, as indicated by block 620 of the method 600.

Returning to the method 600 at block 625, the SPD module 101 may provide the sub-pages to the available decompression engine for decompression of the code residing in the sub-pages. Because there is one available decompression engine, the sub-pages may be provided in a serial manner for decompression, one after another, beginning with the target sub-page that contains the requested code RC. Advantageously, with the sub-pages of the memory page being provided serially to a decompression engine such that a first target sub-page provided includes the requested code RC, the requested code RC may be made available to the processing engine 201 in the amount of time required for the one decompression engine to decompress a single sub-page chunk of code.

At block 630, the decompressed code of each sub-page, including the requested code RC in a certain one of the sub-pages, may be copied to the cache 116 and made available to the processing component 201. Advantageously, if a first sub-page selected for decompression includes the requested code RC, then the decompressed requested code RC may be made be copied to the cache 116 before other sub-pages are decompressed. At block 635, the requested code RC, having been decompressed by the decompression engine at block 625 and copied to the cache 116 at block 630, may be provided to the processing engine 201. The method 600 returns.

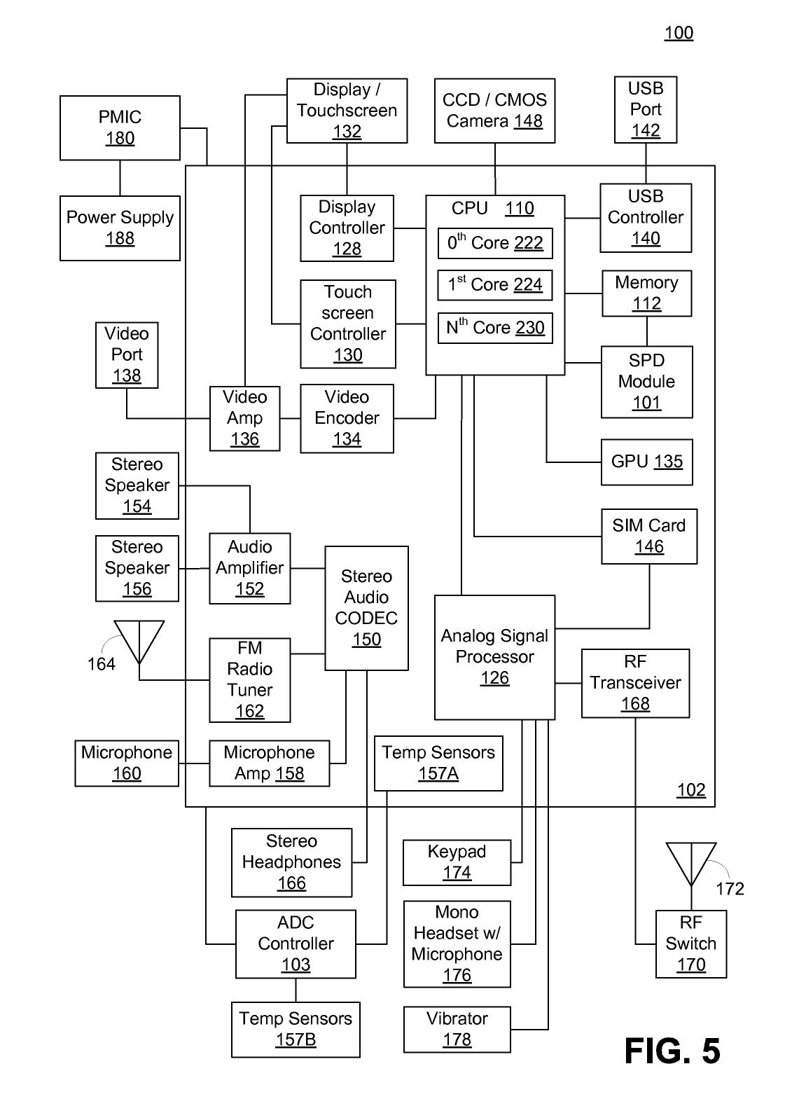

FIG. 5 is a functional block diagram illustrating an exemplary, non-limiting aspect of a portable computing device (“PCD”) 100 in the form of a wireless telephone for implementing selective sub-page decompression (“SSPD”) techniques. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, SPD module 101 may be formed from hardware and/or firmware and may be responsible for decompressing data streams according to various SSPD techniques. As illustrated in FIG. 5, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 5, a universal serial bus (“USB”) controller 140 is coupled to the CPU 110. Also, a USB port 142 is coupled to the USB controller 140. A memory 112, which may include a PoP memory, a cache or tightly coupled memory 116, a mask ROM / Boot ROM, a boot OTP memory, a DDR memory 115 may also be coupled to the CPU 110. A subscriber identity module (“SIM”) card 146 may also be coupled to the CPU 110. Further, as shown in FIG. 5, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 5, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 5 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 5 further indicates that a radio frequency (“RF”) transceiver 168 may be coupled to the analog signal processor 126. An RF switch 170 may be coupled to the RF transceiver 168 and an RF antenna 172. As shown in FIG. 5, a keypad 174 may be coupled to the analog signal processor 126. Also, a mono headset with a microphone 176 may be coupled to the analog signal processor 126. Further, a vibrator device 178 may be coupled to the analog signal processor 126. FIG. 5 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 5 may reside on chip 102 in other exemplary embodiments.

In a particular aspect, one or more of the method steps described herein may be implemented by executable instructions and parameters stored in the memory 112 or as form the SPD module 101. Further, the SPD module 101, the memory 112, the instructions stored therein, or a combination thereof may serve as a means for performing one or more of the method steps described herein.

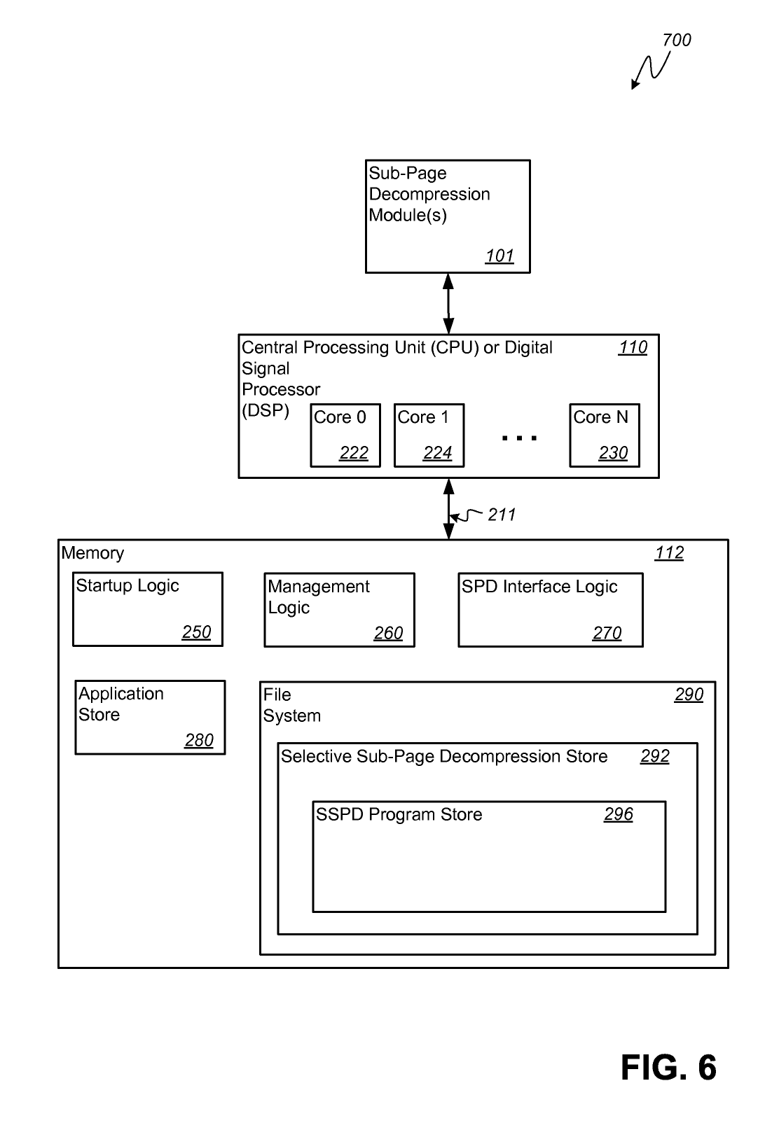

FIG. 6 is a schematic diagram illustrating an exemplary software architecture 700 of the PCD of FIG. 5 for implementing selective sub-page decompression (“SSPD”) solutions. As illustrated in FIG. 6, the CPU or digital signal processor 110 is coupled to the memory 112 via main bus 211. The CPU 110, as noted above, is a multiple-core processor having N core processors. That is, the CPU 110 includes a first core 222, a second core 224, and an N^{th} core 230. As is known to one of ordinary skill in the art, each of the first core 222, the second core 224 and the N^{th} core 230 are available for supporting a dedicated application or program. Alternatively, one or more applications or programs may be distributed for processing across two or more of the available cores.

The CPU 110 may receive commands from the SPD module(s) 101 that may comprise software and/or hardware. If embodied as software, the module(s) 101 comprise instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 6, it should be noted that one or more of startup logic 250, management logic 260, SPD interface logic 270, applications in application store 280 and portions of the file system 290 may be stored on any computer-readable medium for use by, or in connection with, any computer-related system or method. In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the SPD interface logic 270 are implemented in hardware, the various logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The memory 112 may include a non-volatile data storage device such as a flash memory or a solid-state memory device. Although depicted as a single device, the memory 112 may be a distributed memory device with separate data stores coupled to the digital signal processor 110 (or additional processor cores).

The startup logic 250 includes one or more executable instructions for selectively identifying, loading, and executing a select program for decompressing data streams according to SSPD techniques. The startup logic 250 may identify, load and execute a select SSPD program. An exemplary select program may be found in the program store 296 of the embedded file system 290. The exemplary select program, when executed by one or more of the core processors in the CPU 110 may operate in accordance with one or more signals provided by the SPD module 101 to decompress a data stream.

The management logic 260 includes one or more executable instructions for terminating an SSPD program on one or more of the respective processor cores, as well as selectively identifying, loading, and executing a more suitable replacement program. The management logic 260 is arranged to perform these functions at run time or while the PCD 100 is powered and in use by an operator of the device. A replacement program may be found in the program store 296 of the embedded file system 290.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260. By way of example, the inputs may include a change to the default number of sub-pages into which a memory page identified for decompression is divided.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 may be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged Selective Sub-Page Decompression store 292 that may include any number of SSPD solutions. In this regard, the file system 290 may include a reserved section of its total file system capacity for the storage of information for the configuration and management of the various SSPD algorithms used by the PCD 100.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter,” “then,” “next,” “consequently,” etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Therefore, although selected aspects have been illustrated and described in detail, it will be understood that various substitutions and alterations may be made therein without departing from the spirit and scope of the present invention, as defined by the following claims.

What is claimed is:

1. A method for selective sub-page decompression of a memory page in a system on a chip (“SoC”) in a portable computing device (“PCD”), the method comprising:
receiving a request from a processing engine for certain executable code, wherein the certain executable code is stored in a compressed form in a memory device and is associated with a memory page;
retrieving the memory page;
subdividing the memory page into a plurality of sub-pages ordered from a first sub-page to a last sub-page, wherein a certain sub-page of the plurality of sub-pages comprises the certain executable code;
decompressing the sub-pages, beginning with the certain sub-page, wherein the certain sub-page is a sub-page other than the first sub-page; and
providing the certain sub-page in decompressed form to the processing engine, wherein providing the certain sub-page in decompressed form to the processing engine comprises providing the certain executable code in decompressed form to the processing engine.

2. The method of claim 1, wherein subdividing the memory page into a plurality of sub-pages ordered from a first sub-page to a last sub-page further comprises grouping the plurality of sub-pages into sets.

3. The method of claim 2, wherein the certain sub-page of the plurality of sub-pages is a beginning sub-page in a certain set.

4. The method of claim 3, wherein decompressing the sub-pages comprises decompressing with a plurality of decompression engines equal in number to the sets.

5. The method of claim 4, wherein a first decompression engine decompresses the certain sub-page substantially in parallel with a second decompression engine that decompresses a different sub-page associated with a different set than the certain set.

6. The method of claim 1, wherein providing the certain sub-page in decompressed form to the processing engine comprises copying the decompressed sub-page to a cache associated with the processing engine.

7. The method of claim 1, wherein the PCD is in the form of a wireless telephone.

8. A system for selective sub-page decompression of a memory page in a system on a chip (“SoC”) in a portable computing device (“PCD”), the system comprising:
a Sub-Page Decompression (“SPD”) module operable for:
receiving a request from a processing engine for certain executable code, wherein the certain executable code is stored in a compressed form in a memory device and is associated with a memory page;
retrieving the memory page;
subdividing the memory page into a plurality of sub-pages ordered from a first sub-page to a last sub-page, wherein a certain sub-page of the plurality of sub-pages comprises the certain executable code;
decompressing the sub-pages, beginning with the certain sub-page, wherein the certain sub-page is a sub-page other than the first sub-page; and
providing the certain sub-page in decompressed form to the processing engine, wherein providing the certain sub-page in decompressed form to the processing engine comprises providing the certain executable code in decompressed form to the processing engine.

9. The system of claim 8, wherein subdividing the memory page into a plurality of sub-pages ordered from a first sub-page to a last sub-page further comprises grouping the plurality of sub-pages into sets.

10. The system of claim 9, wherein the certain sub-page of the plurality of sub-pages is a beginning sub-page in a certain set.

11. The system of claim 10, wherein decompressing the sub-pages comprises decompressing with a plurality of decompression engines equal in number to the sets.

12. The system of claim 11, wherein a first decompression engine decompresses the certain sub-page substantially in parallel with a second decompression engine that decompresses a different sub-page associated with a different set than the certain set.

13. The system of claim 8, wherein providing the certain sub-page in decompressed form to the processing engine comprises copying the decompressed sub-page to a cache associated with the processing engine.

14. The system of claim 8, wherein the PCD is in the form of a wireless telephone.

15. A system for selective sub-page decompression of a memory page in a system on a chip (“SoC”) in a portable computing device (“PCD”), the system comprising:
means for receiving a request from a processing engine for certain executable code, wherein the certain executable code is stored in a compressed form in a memory device and is associated with a memory page;
means for retrieving the memory page;
means for subdividing the memory page into a plurality of sub-pages ordered from a first sub-page to a last sub-page, wherein a certain sub-page of the plurality of sub-pages comprises the certain executable code;
means for decompressing the sub-pages, beginning with the certain sub-page, wherein the certain sub-page is a sub-page other than the first sub-page; and
means for providing the certain sub-page in decompressed form to the processing engine, wherein providing the certain sub-page in decompressed form to the processing engine comprises providing the certain executable code in decompressed form to the processing engine.

16. The system of claim 15, wherein means for subdividing the memory page into a plurality of sub-pages ordered from a first sub-page to a last sub-page further comprises means for grouping the plurality of sub-pages into sets.

17. The system of claim 16, wherein the certain sub-page of the plurality of sub-pages is a beginning sub-page in a certain set.

18. The system of claim 17, wherein means for decompressing the sub-pages comprises means for decompressing with a plurality of decompression engines equal in number to the sets.

19. The system of claim 18, wherein a first decompression engine decompresses the certain sub-page substantially in parallel with a second decompression engine that decompresses a different sub-page associated with a different set than the certain set.

20. The system of claim 15, wherein means for providing the certain sub-page in decompressed form to the processing engine comprises means for copying the decompressed sub-page to a cache associated with the processing engine.
